(19) United States
(12) Patent Application Publication
(10) Pub. No.: US 2008/0161143 A1
(43) Pub. Date: Jul. 3, 2008

(54) ORBITAL SPEED REDUCER BY BELT

(75) Inventor: VALMOR DA CUNHA GRAVIO, POMPEIA (BR)

Correspondence Address: VALMOR DA CUNHA GRAVIO, RUA WASHINGTON LUIZ 601, POMPEIA - SP, 17580-00, omitted

(73) Assignee: VALMOR DA CUNHA GRAVIO, POMPEIA (BR)

(21) Appl. No.: 11/945,355

(22) Filed: Nov. 27, 2007

(30) Foreign Application Priority Data
Dec. 29, 2006 (BR) PI0605676-8

(51) Int. Cl. F16H 7/14

(52) U.S. Cl. 474/112

(57) ABSTRACT

It is an epicyclic gear system for use in speed reducer or overdrive, however using an inner pulley, an external ring and a driving belt or a tire instead of using toothed gears. The system particularity is an inner pulley drivingly coupled to an external ring and the torque transmission between the inner pulley and the external ring is done through a belt or a tire, as either the inner pulley or the external ring has orbital motion.

### FIELD OF THE INVENTION

The present invention relates to a planetary gear mechanism used for speed reduction or overdrive and, in particular, to the use of one inner pulley drivingly connected by a drive belt or a tire to an outer ring, where either the inner pulley or the outer ring has orbital motion.

### BACKGROUND OF THE INVENTION

Planetary or epicyclic gear systems for use in speed reducers are a long time known. One example of such system is described in U.S. Pat. No. 276,776, issued to George F. Clemons on May 1, 1883. There are known mechanisms of epicyclic speed reduction, which typically include a pinion gear in orbit coupled to an internally toothed gear. These transmissions make possible great speed reduction however there is the limiting factor, which is the precise aspect of the complicated teeth and the transmitted torque limitation due to the small contact area between the teeth of the gears.

### SUMMARY OF THE INVENTION

The present invention provides other possibility to use the idea of the planetary gear mechanism in a reduction gear or an overdrive gear, using pulleys instead of toothed gears. The great advantage of this type of pulley reducer or overdrive is the great reduction reached in just one reduction stage besides the very simple structure. For equipments which use low torques, such as toys, the use of gasket o-ring working as a belt in this technique, can make the production cost to be lower than the conventional mechanical reduction. For higher power transmissions, the use of multiple channels belts as “POLI V” belts or tires, for instance, makes possible to have low cost mechanism.

The invention allows a variety of reductions ratio in compact sets with very few parts in a single stage or multiple stages for big reductions or overdrive.

These and others aspects of the present invention are herein described in particularized detail with reference to the accompanying Figures, as non-limited examples.

### BRIEF DESCRIPTION OF THE FIGURES

FIG. 1 presents a frontal view in a schematic representation of a didactic reducer model with a fixed external ring.

FIG. 2 presents the FIG. 1 model added by a flexible surface to increase the contact between the internal pulley and the belt, and the pulley has four pins axially fixed in it.

FIG. 3 presents an overview in longitudinal cross-section of a reducer coupled to an engine according to FIG. 2.

FIG. 4 presents a second reducer modality where the external ring has rotational motion and the pulley has four cavities, which suit the four structure-based pins.

FIG. 5 illustrate an overview in longitudinal cross-section of a building possibility for the reducer model of FIG. 4 coupled to an engine.

FIG. 6 presents an overview in longitudinal cross-section of a building possibility for a reducer model of FIG. 4 where the eccentric cam belongs to the entrance element, the output shaft is supported on the reducer case and the belt is structured as a tire.

FIG. 7 presents other version of FIG. 3 model with the external ring in orbital and rotational motion and the drivingly coupling between the external ring and the output rotary element also made through a belt structured as a tire.

### DESCRIPTION OF THE PREFERRED EMBODIMENTS

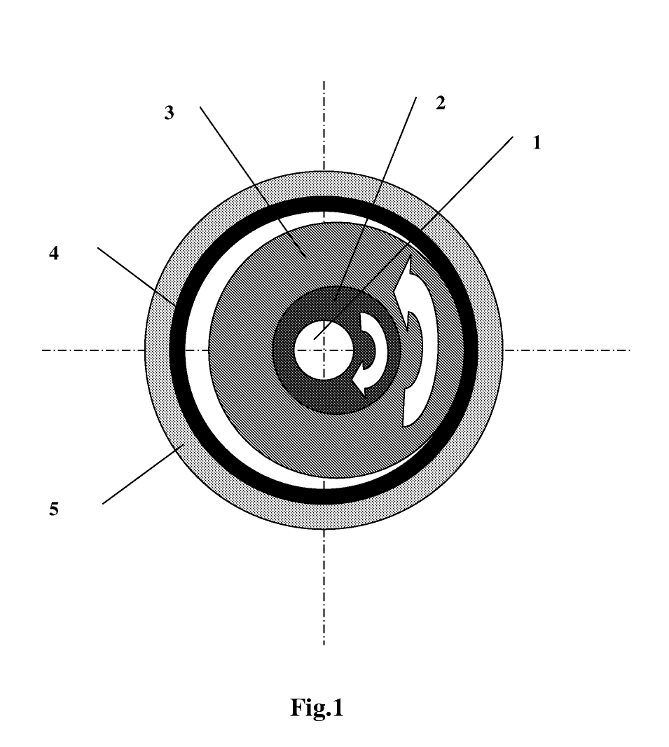

The functioning principle of such a reducer can be seen in FIG. 1 which is the first constructive modality where the rotational motion of the input element 1 makes the eccentric cam 2 moves in orbital motion which is reciprocal to and moving, the eccentric cam 2 transmits the orbital motion to the pulley 3. The pulley 3 rotates in the eccentric cam 2. The belt 4 makes the drivingly coupling between the pulley 3 and the external ring 5 to which is reciprocal to. In this case, the external ring 5 is reciprocal to the reducer structure therefore it does not turn. As represented in FIG. 1, the rotary motion of the input element 1 in one direction, makes the pulley 3 drivingly coupled to the external ring 5 rotates in an opposite direction. Without taking into account an eventual slipping between the pulley 3 and the belt 4, the transmission relation between the rotation of the input element 1 and the pulley 3 is given by the pitch diameter of the pulley 3 divided by the difference between the pitch diameter formed in the belt 4 and the pitch diameter of the pulley 3. The lower the difference between the external ring diameter 5 and consequently the formed one in the belt 4 and the pulley 3 higher the reduction. On the other hand, the decreasing of the diameter difference between the formed one in the belt 4 and the pulley 3 makes the contact area between both of them bigger. The pitch diameter formed in the belt 4 is what it would be if it were in the round format.

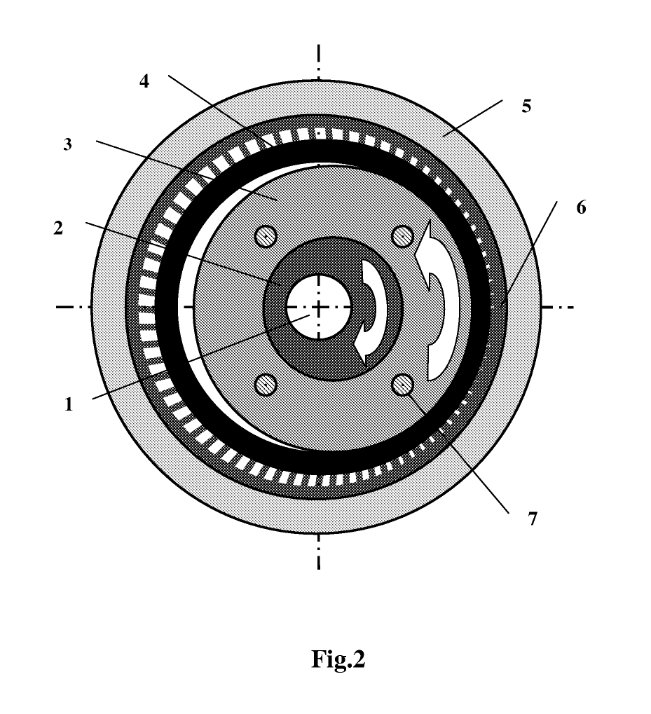

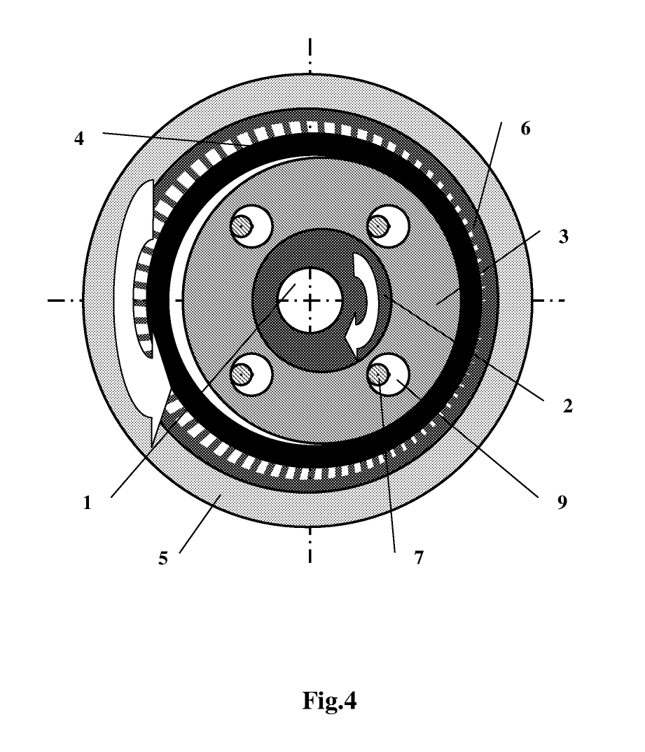

There are two constructive modalities for this reducer as for each of these modalities both the pulley 3 and the external ring 5 can be designed to be set either on the eccentric cam 2 or placed on the same center of the input element 1, therefore when one is on the eccentric cam 2 the other is placed on the same center of the input element 1. In a first modality as represented in FIGS. 1 and 2 with the pulley 3 or the external ring 5 reciprocal to the reducer case and placed on the same center of the input element 1. In this modality as there are orbital and rotational motion in the element set on the eccentric cam 2 it is necessary a special coupling to transfer only rotational motion to the reducer output, since normally the orbital motion is not desirable. On a second constructive modality represented in FIG. 4, the external ring 5 or the pulley 3 is activated by the eccentric cam 2 motion and coupled to the case reducer in a way that the coupling allows only the orbital motion and not the rotary motion of the external ring 5 or the pulley 3. In this constructive modality if we have, for instance, the pulley 3 in orbital motion coupled to the case, it makes through the belt 4 the rotational motion of the external ring 5 which is placed on the same center of the input element 1 so the external ring 5 suits as a reducer output element. As aforementioned, we can have the opposite situation with the external ring 5 placed on the eccentric cam 2 and the pulley 3 as reducer output element.

In FIG. 2 we have the first constructive modality in which case there is an external ring 5 reciprocal to the reducer structure and concentrically placed with the input element 1, and the pulley 3 is set on the eccentric cam 2 and it has, as an example, four pins 7 fixed to it, which make part of the coupling to transmit only rotational motion from the pulley 3, and not orbital motion, to an output element which rotates concentrically with the input element 1. The flexible surface 6 is reciprocal to the external ring 5 and to the belt 4 and it serves to increase the contact area between the pulley 3 and the belt 4 as it deforms itself under the pressure of the pulley 3 on the belt 4 during the pulley 3 orbital motion.

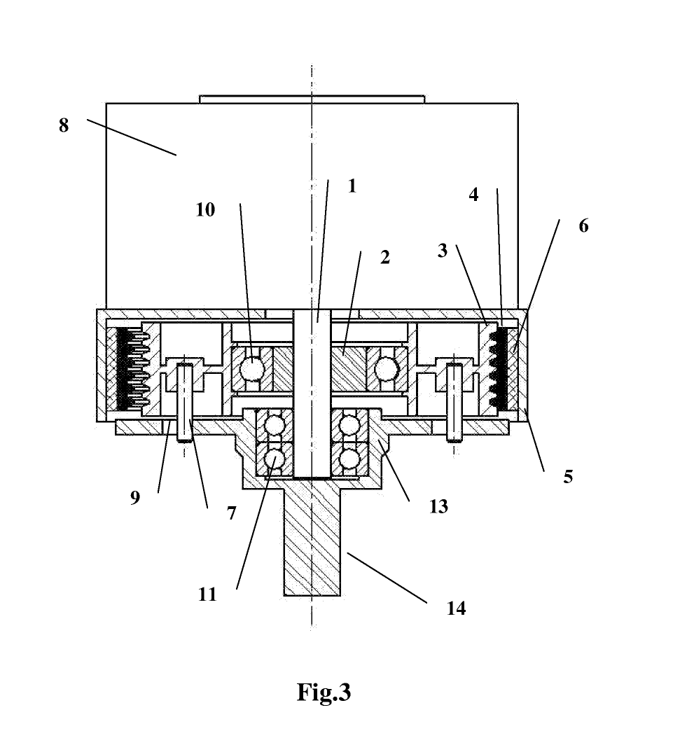

We have in FIG. 3 a longitudinal cross-section of a reducer coupled to an engine 8. This is a constructive possibility to the model of FIG. 2. In this construction the external ring 5 is reciprocal to the engine 8 case which also serves as reducer structure and the output of the reducer is done through the shaft 14 which belongs to the rotating element 13 which is coupled to the pulley 3 through the fitting of its four cavities 9 in the four pins 7 fixed in the pulley 3. Through this coupling of the four pins 7 of pulley 3 with the four cavities 9 of the rotating element 13 is transmitted from the rotational and orbital motion of the pulley 3 only a rotational motion to the rotating element 13. The cavities 9 have bigger diameter than the pins 7, the diameter of the cavity 9 is equal the diameter of the pins 7 more twofold the eccentricity of the eccentric cam 2. Therefore the power input in the reducer is done through the input element 1 of the engine 8 it has its output in the shaft 14 of the reducer.

We have in FIG. 4 the second constructive modality of the reducer where the external ring 5 rotates and in this example is reciprocal with the flexible surface 6 and the belt 4. The pulley 3 is coupled to the reducer structured, which in this example is done through the fitting of its four cavities 9 in the four pins 7 fixed in the reducer structure. In this case as in the former one the cavity diameter 9 is the sum of the pin 7 diameter added twofold the eccentricity of the eccentric cam 2 in relation with the input element 1. This coupling of the pulley 3 with the reducer structure only allows the orbital motion and eliminates the possibility of pulley 3 rotation around the same center of the input element 1. The rotary motion of the input element 1 and consequently the eccentric cam 2 reciprocal to it, produce an orbital motion on the pulley 3 which under the restriction of the rotation imposed by the four pins 7 fitted in the four cavities 9 and in contact with the belt 4, rotates the whole belt 4, flexible surface 6 and external ring 5 which are reciprocal to it. The rotation direction of the external ring 5 set is opposite to the direction of the rotation of the input element 1. Not taking into account eventual slipping between the pulley 3 and the belt 4, the transmission relation for this second modality between the input element 1 and the external ring 5 is given by the pitch diameter formed in the belt 4 divided by the difference of the pitch diameters of the belt 4 and the pulley 3. In this situation the belt pitch diameter 4 is also the pitch diameter to the belt in the round shape. The function of the flexible surface 6 in the same way as example of picture 2, it is to deform as, it is compressed by the belt 4 through the pulley 3 action, so to increase contact area between the pulley 3 and the belt 4. The increase of the contact area between the pulley 3 and the belt 4 increases the dragging between the surfaces and it makes it possible the use of bigger transmission torques.

In the examples of FIGS. 2 and 4, which represent the two constructive modalities, the flexible surface 6, could be performed with a rubber material, it could be a flexible surface with steel rope, it could also be part of in a special belt for this suiting, with the flexible surface 6 integrated with the belt 4 forming a single set as a car tire. The different suiting for this reducer family can require different solutions for the belt set.

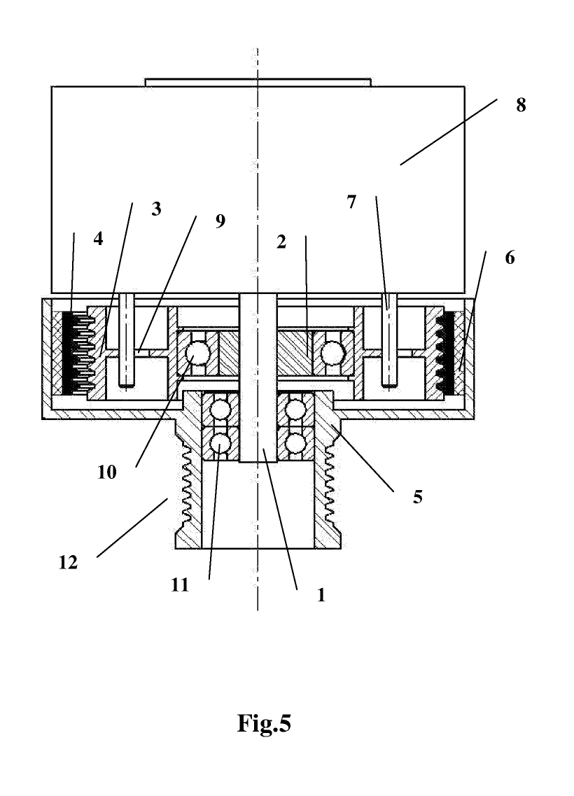

We have in FIG. 5 a longitudinal cross-section of a coupled reducer to an engine 8. This reducer is the model of FIG. 4, where to improve the slipping between the eccentric cam surfaces 2 and the pulley 3 it was used a bearing 10. It was also used two bearings 11 between the input element 1 and the external ring 5, which in this case also has a pulley 12 as an integral part. The pulley 12 of the external ring 5 is only an example of a possibility of the reducer output power. In this example the pulley 3 is coupled to the engine 8 case, which also works as a reducer structure, being the coupling done through the suiting of the four pins 7 in the four cavities 9 of the pulley 3. The four pins 7 are fixed on the engine case.

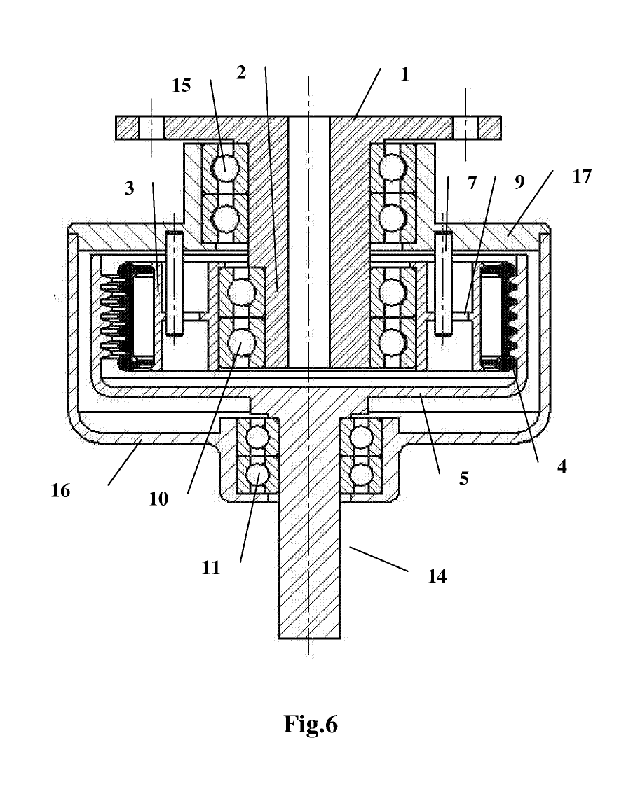

Another constructive possibility for this second reducer modality can be seen in FIG. 6 where the reducer input element 1 has the eccentric cam 2 as its integral part and, as an example, the entrance element 1 has a flange for the power input connection. The external ring 5 is movable rotating on the bearings 11, which bearings 11 are supported on the case 16 and the reducer output power is done through the shaft 14, which is an integral part of the external ring 5. In this construction the belt 4 is build as a tire and set on the pulley 3, being reciprocal to it. On the same way, as a tire deforms itself as is under pressure, this belt 4, having similar construction of a tire, deforms itself as it is pressed between the external ring 5 and the pulley 3, taking shape between the two elements, consequently increasing the contact area between the belt 4 and the external ring 5. The pins 7 are fixed on the flange 17. So the rotation of the input element 1 with the eccentric cam 2 which is part of it moves the pulley 3 in orbital motion through the bearings 10. The pulley 3 is coupled to the reducer structure through the suiting of its four cavities 9 in the four pins 7, which only allow orbital motion and not rotational motion of the pulley 3 in relation with the axis of the input element 1. Therefore the pulley 3 transmits torque to the external ring 5 through the belt 4, making the external ring 5 to rotate.

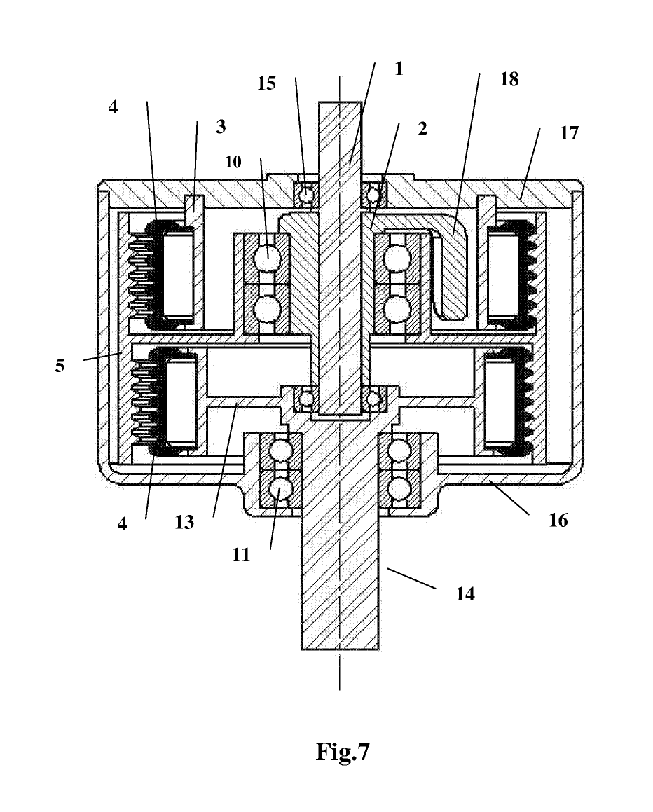

FIG. 7 presents a constructive possibility for this type of reducer being different from the one presented in FIG. 3 as it has an external ring 5 set on the eccentric cam 2 and the pulley 3 reciprocal to the flange 17 and concentric to the input element 1 This way the rotation of the input element 1 moves the eccentric cam 2, which is reciprocal to it, which the eccentric cam 2 moves in orbital motion the external ring 5 through two bearings 10. In this example of FIG. 7 the eccentric cam 2 has a counter-weight 18 to balance the unbalanced power raised by the orbital motion, therefore avoiding vibrations, which normally are undesirable. The orbital motion of the external ring 5 coupled to the pulley 3 through the belt 4 which is reciprocal to the pulley 3, adds a rotational motion on the external ring 5. The external ring 5 rotational motion is transferred to the rotating element 13 through a belt 4, which is reciprocal to the rotating element 13. In this example, the torque transference between the external ring 5 and for both the pulley 3 and the rotating element 13 are performed by two different belts 4. The reducer output power is performed through shaft 14, which is part of the rotating element 13. In this case the transmission relation is different from the former examples, since that belt coupling allows the transmission from orbital and rotational motion of the external ring 5 to the rotating element 13. This example shows that a reducer can be built both with pulley 3 and with an external ring 5 set one on the eccentric cam 2 and the other concentric with the input element 1 maintaining the same functioning principle on the two constructive modalities.

Generally that reducer is suitable to big speed reductions due to being necessary a contact angle between the pulley 3 and the belt 4 which assures the suitable pulling between the surfaces, what keeps the reducer transmission relation and avoids a belt early wear. As we can observe in the figures, if there is any big difference in the diameter between the pulley 3 and the belt 4 it will hardly increase the contact area between the belt 4 and the pulley 3 suitably and for those cases the use of a conventional transmission or another type of reducer can provide a better suitable solution.

All the shown examples herein, of such a reducer, can be set sequentially in various reducing stages through coupling of reducers or performed by a construction of a reducer with various reducing stages on the same case.

What is claimed is:

1. Orbital speed reducer by belt comprising for each stage of reduction an input element 1 for input power,
an eccentric cam 2 which is reciprocal to the input element 1 or is part of the input element 1
and a pulley 3 which is inwardly drivingly coupled to an external ring 5,
since either the pulley 3 is concentric with the input element 1
and the external ring 5 rotates in the eccentric cam 2 through bearings, bushings, etc or directly through slipping contact; or
the pulley 3 rotates in the eccentric cam 2 through bearings, bushings, etc or directly through slipping contact; and
the external ring 5 is concentric with the input element 1; and
the torque transmission between the pulley 3 and the external ring 5 is done by the belt 4.

2. Orbital speed reducer by belt of claim 1, wherein the belt 4 is a tire or is a drive belt reciprocal with a compressible and flexible material or is some similar flexible component and the belt 4 is reciprocal with either the pulley 3 or with the external ring 5.

3. Orbital speed reducer by belt of claim 1, wherein the external ring 5 is reciprocal to a reducer structure; and
the pulley 3 is set on the eccentric cam 2, which the pulley 3 is coupled to the rotating element 13
which rotating element 13 is supported on the input element 1 or on the reducer structure in the same axis of the input element 1 through bearings, bushings, etc or directly through slipping contact, through which the rotating element 13 there is the reducer output,

4. Orbital speed reducer by belt of claim 1, wherein the pulley 3 being reciprocal to the reducer structure; and
the external ring 5 set on the eccentric cam 2, which the external ring 5 is coupled to the rotating element 13
which rotating element 13 is supported on the input element 1 or on the reducer structure in the same axis of the input element 1 through bearings, bushings, etc or directly through slipping contact, through which the rotating element 13 there is the reducer power output.

5. Orbital speed reducer by belt of claim 1, wherein the pulley 3 is set on the eccentric cam 2 and coupled to the reducer structure, and
the external ring 5 rotates concentrically with the input element 1 supported on the input element 1 or on the reducer structure through bearings, bushings, etc or directly through slipping contact, through which the external ring 5 there is the reducer power output.

6. Orbital speed reducer by belt of claim 1, wherein the external ring 5 is set on the eccentric cam 2 and coupled to the reducer structure,
the pulley 3 rotates concentrically with the input element 1 supported on the input element 1 or on the reducer structure through bearings, bushings, etc or directly through slipping contact, through which pulley 3 there is the reducer power output.
